(19) United States
(12) Patent Application Publication
(10) Pub. No.: US 2025/0301443 A1
(43) Pub. Date: Sep. 25, 2025

(54) Wireless Access Point Locationing

(71) Applicant: Arista Networks, Inc., Santa Clara, CA (US)

(72) Inventors: Sikha V. Manoj, Bangalore (IN); Vijayalakshmi Chetlapalli, Pune (IN); Parag Mittal, Pune (IN); Rachit Srivastava, Pune (IN); Apurva R. Patel, Pune (IN); Jatin Parekh, Mumbai (IN)

(21) Appl. No.: 18/613,573

(22) Filed: Mar. 22, 2024

(51) Int. Cl. H04W 64/00

(52) U.S. Cl. CPC H04W 64/003

(57) ABSTRACT

A wireless access point may obtain its location based on a location message received from a neighboring device and containing a geolocation of a geolocation reference device. The wireless access point may transmit a location message containing its location relative to the geolocation such that one or more additional wireless access points may obtain their locations based on the transmitted location message.

### BACKGROUND

A communication system includes multiple network devices that are interconnected to form a network for conveying network traffic between hosts. The network devices at the edge portions of the network can include wireless access points that provide wireless connectivity for the hosts (e.g., client devices). It may be desirable to coordinate operations of the wireless access points to provide the wireless coverage more efficiently and/or to comply with governmental regulations.

### BRIEF DESCRIPTION OF THE DRAWINGS

FIG. 1 is a diagram of an illustrative network having wireless access points to which client devices are communicatively coupled in accordance with some embodiments.

FIG. 2 is a diagram of an illustrative wireless access point in accordance with some embodiments.

FIG. 3 is a diagram of an illustrative wireless access point configured to obtain location information based on a geolocation information source in accordance with some embodiments.

FIG. 4 is a diagram of an illustrative wireless access point configured to obtain location information based on a neighboring wireless access point that obtained location information based on a geolocation information source in accordance with some embodiments.

FIG. 5 is a diagram of an illustrative wireless access point configured to obtain location information selectively from one of many neighboring devices in accordance with some embodiments.

FIG. 6 is a flowchart of illustrative operations for communicating with a wireless network coordination system in accordance with some embodiments.

FIG. 7 is a flowchart of illustrative operations for obtaining wireless access point location information in accordance with some embodiments.

### DETAILED DESCRIPTION

A network can convey network traffic, e.g., in the form of frames, packets, etc., between hosts. These hosts may include client devices coupled to wireless access points in the network and, through the wireless access points, may be connected to other network devices that form a wired portion of the network.

Wireless access points may operate in different radio-frequency bands to provide wireless connectivity to client devices. To operate in one or more radio-frequency bands, it may be necessary or desirable for all wireless access points intending to operate in the radio-frequency band(s) to communicate with a wireless access point management system (e.g., a wireless access point coordination system) prior to operating in the radio-frequency band(s). In particular, each wireless access point may communicate its location information to the management system and receive operating parameters from the management system that promote its coexistence with other incumbent systems (e.g., other wireless access points or generally other radio-frequency sources) operating in the same radio-frequency band(s).

While some wireless access points may include Global Positioning System (GPS) modules that can directly obtain geolocation information for reporting to the management system, other wireless access points may be unable to obtain their geolocation information. To ensure that location information (for reporting to the management system) can be obtained by a group of wireless access points, the group of wireless access points may employ a cascading mechanism for locationing such that wireless access points that otherwise would be unable to obtain their geolocation information can obtain location information based on neighboring devices.

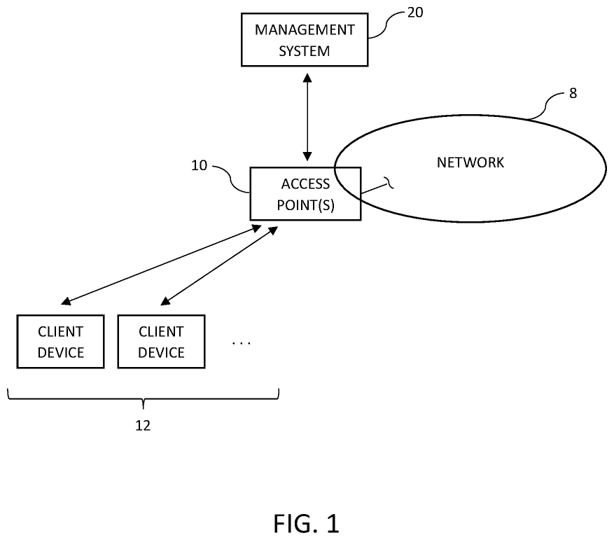

In some illustrative configurations described herein as an example, a wireless access point may receive a message containing location information of a neighboring device. The wireless access point may obtain its own location information based on the location information of the neighboring device and based on a measurement of a distance to the neighboring device. The wireless access point may subsequently send its own location information in a message such that other wireless access points can similarly obtain their location information. An illustrative networking system in which this type of cascading mechanism for wireless access point locationing may be employed is shown in FIG. 1.

In the example of FIG. 1, the networking system may include a network such as network 8. Network 8 may be of any suitable scope (e.g., implemented as a campus area network, as a local area network (LAN), as a virtual local area network (VLAN) domain, etc.). Network 8 may include a wired network portion based on wired technologies or standards such as Ethernet (e.g., using copper cables and/or fiber optic cables) and a wireless network portion such as wireless local area networks (WLANs) (e.g., Wi-Fi networks compliant with the IEEE 802.11 family of standards). If desired, network 8 may also include internet service provider networks (e.g., the Internet) or other public service provider networks, private service provider networks (e.g., multiprotocol label switching (MPLS) networks), and/or may other types of networks such as telecommunication service provider networks.

Network 8 may be implemented using one or more network devices that handle (e.g., process by modifying, forwarding, etc.) network traffic to convey information for user applications between end hosts and/or generally for other applications between devices. In general, network 8 can include networking equipment forming a variety of network devices that interconnect end hosts of network 8. These network devices of network 8 may include one or more wireless access points, one or more switches (e.g., multi-layer (Layer 2 and Layer 3) switches, single-layer (Layer 2) switches, etc.), one or more bridges, one or more routers or gateways, one or more hubs, one or more repeaters, one or more firewalls, one or more devices serving other networking functions, one or more devices that include the functionality of two or more of these devices, and/or management equipment that manage and control the operation of one or more of these network devices.

End hosts of network 8 can include computers, servers, portable electronic devices such as cellular telephones and laptops, other types of specialized or general-purpose host computing equipment (e.g., running one or more client-side and/or server-side applications), network-connected appliances or devices such as cameras, thermostats, wireless sensors, medical, health, or other sensors, lighting fixtures, speakers, printers, controllers, and other network-connected equipment that serve as input-output devices and/or computing devices in a distributed networking system, devices used by network administrators (sometimes referred to as administrator devices), network service devices, and/or management equipment that manage and control the operation of one or more of other end hosts and/or network devices.

Configurations in which network 8 includes one or more wireless access points 10 that implement a wireless network (portion) for network 8 are sometimes described herein as an illustrative example. In these configurations, the end hosts connected to network 8 via wireless access points 10 are often referred to as client devices or client stations (e.g., client devices or client stations 12 in FIG. 1). Each wireless access point 10 may operate in one or more radio-frequency bands (e.g., a 2.4 GHz radio-frequency band, a 5 GHz radio-frequency band, a 6 GHZ radio-frequency band, etc.) and provide wireless coverage using one or more corresponding radio-frequency channels in each operating radio-frequency band. One or more client devices 12 operating in a given frequency band may wirelessly connect (e.g., establish a wireless communication link) to a given wireless access point 10 operating in the same frequency band.

Wireless access points 10 may communicate with a wireless access point management system such as management system 20 (sometimes referred to herein as coordination system 20). In some configurations described herein as an example, management system 20 may be an Automated Frequency Coordination (AFC) system (e.g., that coordinates operations of wireless access points and/or other radio-frequency devices in the 6 GHz radio-frequency band). If desired, management system 20 may be another type of wireless access point management or coordination system that coordinates the operation of a group of wireless access points (e.g., by providing complementary access point operating parameters and/or access point configuration data) or generally controls the operation of wireless network components to enhance wireless coverage and performance.

In one illustrative arrangement, management system 20 may be implemented on server equipment (e.g., as a wireless access point management server). The server equipment may include server hardware such as one or more blade servers, one or more rack servers, and/or one or more tower servers. Compute devices and storage devices for implementing the functions of management system 20 may be provided as part of the server hardware. The compute devices may include one or more processors or processing units based on any suitable combination of processor architectures. The storage devices may include non-volatile memory such as hard disk drive storage and solid-state storage, volatile memory such as random-access memory, and/or other storage circuitry. More specifically, the storage devices may include one or more non-transitory (tangible) computer-readable storage media that stores the operating system software and/or any other software code, sometimes referred to as program instructions, software, data, instructions, or code. The compute devices may run (e.g., execute) an operating system and/or other software and firmware stored on the one or more non-transitory computer-readable storage media memory to perform desired operations of management system 20. In other illustrative arrangements, management system 20 may be implemented on one or more dedicated local controller devices or generally implemented using non-server hardware.

Management system 20 may perform wireless network management and/or wireless device coordination by communicating with each wireless access point 10 via a corresponding communication path. These communication paths may include (wired) network paths through network 8 (e.g., through the network devices therein, using the Internet, etc.). While wireless access points 10 are shown in FIG. 1 as being outside of network 8, this is merely illustrative. As described above, access points 10 may form a part of network 8 (e.g., may form a wireless network portion of network 8).

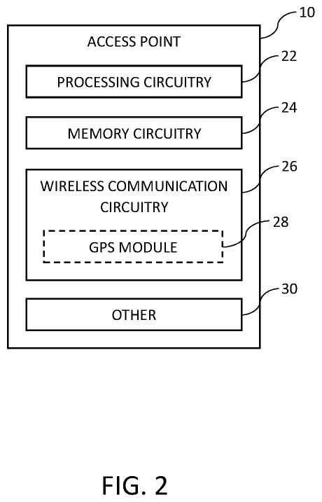

FIG. 2 is a diagram of an illustrative hardware configuration for a network device such as each of wireless access point 10 in FIG. 1. As shown in FIG. 2, wireless access point 10 may include processing circuitry 22, memory circuitry 24, wireless communication circuitry 26, and other components 30 such as input-output interfaces or ports.

Processing circuitry 22 may include one or more processors or processing units such as general-purpose processors (e.g., a central processing unit (CPU)), microprocessors, microcontrollers, digital signal processors, programmable logic devices (e.g., field-programmable gate array (FPGA) devices), application specific system processors (ASSPs), application specific integrated circuit (ASIC) processors, graphics processing units (GPUs), and other types of processors or processing units. Memory circuitry 24 may include volatile memory such as dynamic random-access memory, static random-access memory, etc., non-volatile memory such as hard-drive storage, solid-state storage, flash memory, etc., and/or other types of memory circuitry.

In general, the operations of wireless access point 10 described herein may be stored as (software) instructions on one or more non-transitory computer-readable storage media (e.g., part of memory circuitry 24) in wireless access point 10. The corresponding processing circuitry (e.g., processing circuitry 22) in wireless access point 10 for these one or more non-transitory computer-readable storage media may process the respective instructions to perform the corresponding wireless access point operations. At least some portions of processing circuitry 22 and at least some portions of memory circuitry 24, collectively, may sometimes be referred to herein as the control circuitry of wireless access point 10 because the two portions are often collectively used to control one or more other components of wireless access point 10 (e.g., by exchanging requests, responses, control signals, data, and/or other information with the one or more other components) to perform wireless access point functions.

Wireless access point 10 may include wireless communication circuitry 26 configured to wirelessly communicate with client devices 12 (FIG. 1) and generally provide wireless communication capabilities. Wireless communication circuitry 26 may include one or more radios (e.g., Wi-Fi radios), radio-frequency transceiver circuitry, radio-frequency front-end circuitry, and one or more antennas. The one or more radios may use the one or more antennas to transmit radio-frequency signals to and receive radio-frequency signals from one or more client devices 12. While wireless communication circuitry 26 is shown as a separate element from processing circuitry 22, this is merely illustrative. If desired, portions of wireless communication circuitry 26 (e.g., radio functionalities) may be implemented as a portion of processing circuitry 22.

Access point 10 may include other components 30 such as one or more input-output interfaces or ports (on which the interfaces are implemented). As an example, these ports may include Ethernet ports or other types of network interfaces that generally provide wired connectivity to other network elements in network 8 (e.g., switches, routers, modems, controllers, servers, client devices, etc.), management ports through which wireless access point 10 is controlled and managed, power ports through which power is supplied to wireless access point 10, and/or other types of ports. In general, these input-output components 30 and/or wireless communication circuitry 26 may provide external communication interfaces (e.g., Bluetooth interfaces, Wi-Fi interfaces, Ethernet interfaces, optical interfaces at one or more optical ports, and/or other networking interfaces) for connecting wireless access point 10 to a wireless local area network, a local area network, the Internet, a wide area network, a mobile network, other types of networks, and/or to external devices such as other network device(s) in network 8, client device(s) 12, peripheral devices (e.g., a display), and/or other external equipment.

If desired, other components 30 on wireless access point 10 may include other input-output devices such as devices that provide user output such as a display device (e.g., one or more status lights) and/or devices that gather user input such as one or more buttons. If desired, other components 30 on wireless access point 10 may include one or more sensors such as radio-frequency sensors. If desired, wireless access point 10 may include other components 30 such as a system bus that couples the internal components of wireless access point 10 to one another, to power management components, etc. In general, each component within wireless access point 10 may be interconnected to the control circuitry (e.g., processing circuitry 22 and/or memory circuitry 24) in wireless access point 10 via one or more paths that enable the reception and transmission of control signals, data, and/or other information.

Still referring to FIG. 2, wireless communication circuitry 26 (e.g., the radios, other radio-frequency circuitry, and antennas therein) may be configured to operate in one or more radio-frequency bands such as a 2.4 GHz radio-frequency band, a 5 GHz radio-frequency band, a 6 GHz radio-frequency band, and/or other radio-frequency bands. To operate in one or more of these radio-frequency bands, it may be necessary or desirable for wireless access points 10 intending to operate in the frequency band(s) to communicate with a management system (e.g., management system 20 in FIG. 1) prior operating in the frequency band(s). In particular, each wireless access point 10 may communicate its location information to the management system and may receive parameters for operating in the radio-frequency band(s) from the management system.

Configurations in which wireless access points 10 communicate their location information to the management system (e.g., an AFC system) prior to operating in a 6 GHz radio-frequency band are sometimes described herein an illustrative example. However, if desired, wireless access points 10 may generally communicate their location information with one or more management systems prior to and/or periodically during operations in any desired radio-frequency band(s). The use of wireless access point location information in configuring a group of wireless access points for operation in a particular radio-frequency band may generally satisfy governmental regulations, provide standards-compliant deployments, and/or enable more efficient wireless coverage and deployment, among other advantages.

Wireless communication circuitry 26 in at least some wireless access points 10 of network 8 may include (satellite-based) geopositioning circuitry such as an on-device Global Positioning System (GPS) module 28 (e.g., containing a GPS radio, receiver, antenna, and other components for receiving and processing signals from a satellite navigation system). GPS module 28 of a given wireless access point 10 may be configured to obtain a geolocation specified by geographical coordinates (e.g., GPS longitudinal and latitudinal coordinates) of the given wireless access point 10. Accordingly, these wireless access points 10 may obtain their location information (e.g., their geolocations) directly using their respective GPS modules 28 and report their location information to the management system (e.g., system 20 in FIG. 1).

Other wireless access points 10 may lack an on-device GPS module 28 or may be unable to directly obtain their geolocation (e.g., geographical coordinates) even when an on-device GPS module 28 is present (e.g., because its on-device GPS module 28 is inactive or faulty, because its on-device GPS module 28 is unable to perform appropriate (line-of-sight) communications with navigational satellite(s), etc.). Because these other wireless access points 10 are unable to obtain and report their geolocation to the management system, they may be prohibited from operating in certain radio-frequency bands (e.g., a 6 GHz radio-frequency band), or in other scenarios, may operate suboptimally in certain radio-frequency bands.

The use of GPS-based systems as described herein is merely illustrative. If desired, the wireless communication circuitry described herein may similarly obtain geographical coordinates based on other types of geopositioning systems (e.g., based on the Global Navigation Satellite System (GLONASS), based on the BeiDou Navigation Satellite System, based on the Galileo navigation satellite system, etc.), and similar issues as described above may arise when these other types of geopositioning systems are used.

To ensure that location information can be obtained and reported by all suitable wireless access points 10 of network 8 (regardless of whether they can directly obtain their own geolocation), a cascading mechanism for locationing may be employed by wireless access points 10 (e.g., particularly by wireless access points 10 that otherwise would be unable to obtain their location information and would be unable to operate in frequency band(s) that necessitate the reporting of location information).

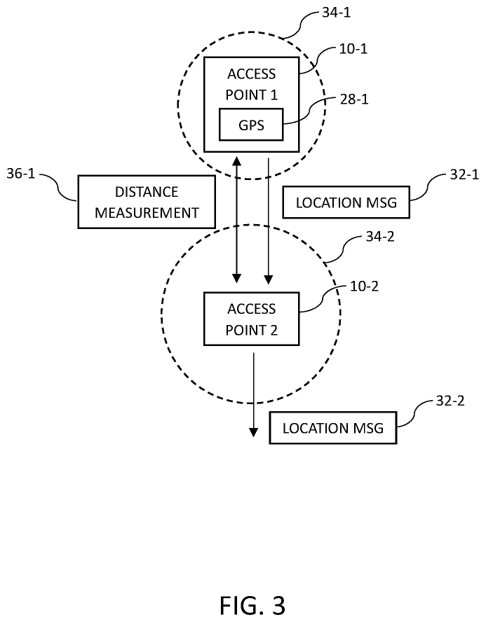

FIGS. 3-7 provide examples illustrating various aspects of the cascading mechanism for wireless access point locationing. In these examples, various messages are exchanged or generally various forms of communication may take place between devices. The various forms of communication (e.g., messages containing location information, distance measurement messages or signals, etc.) to obtain access point location information may occur in one or more radio-frequency bands that have no location reporting requirement (e.g., reporting of access point location prior to the access point operating in the radio-frequency band(s) is not necessitated by governmental regulations, to ensure standards-compliance, and/or network policy). As one illustrative example, an access point intending to operate in a 6 GHz radio-frequency band may need to meet an associated location reporting requirement (e.g., which necessitates the reporting of access point location information to an AFC system) prior to permitted operations in the 6 GHz radio-frequency band. Accordingly, the various forms of communication with the access point for obtaining the access point location information (e.g., as described in connection with FIGS. 3-7) may occur in a non-6 GHz radio-frequency band (e.g., in a 2.4 GHz radio-frequency band and/or in a 5 GHz radio-frequency band).

FIG. 3 is a diagram of first and second illustrative wireless access points 10-1 and 10-2 in network 8 (e.g., two instances of access point 10 in FIGS. 1 and 2). Wireless access point 10-1 may include an on-device GPS module 28-1 (or other types of geopositioning circuitry) configured to obtain a geolocation of wireless access point 10-1. In some illustrative arrangements described herein as an example, wireless access point(s) (e.g., wireless access point 10-1) serve as the geolocation reference device(s). However, this example is merely illustrative. If desired, other types of devices (e.g., client devices 12, other types of network devices in network 8, and/or generally any suitable equipment containing geopositioning circuitry) may serve as the geolocation reference device(s) to facilitate wireless access point locationing as described herein (e.g., based on a cascading mechanism). Accordingly, wireless access point 10-1 may sometimes be referred to herein generally as a geolocation reference device, especially in the context of other devices (e.g., other access points 10) obtaining their location information relative to (e.g., in reference to) the geolocation determined by the geopositioning circuitry of the geolocation reference device.

When obtaining its geolocation using the geopositioning circuitry, wireless access point 10-1 may also obtain a corresponding location uncertainty value (e.g., based on any uncertainty in the measurement of its geolocation by the geopositioning circuitry). In some illustrative examples described herein, the location uncertainty value (sometimes referred to herein as the confidence interval) may be a distance value. The distance value may be indicative of a radius of a circular area (e.g., the area of dashed circle 34-1 with the device geolocation at its center) within which the device is located with a given confidence level (e.g., a confidence level of at least 90%, at least 95%, at least 99%, etc.). In other words, the more confident (i.e., the less uncertain) a given device's geolocation is, the smaller the uncertain value or the radius (and therefore area) defining the expected geolocation of the device should be.

Wireless access point 10-1 may report its determined geolocation and the confidence interval to management system 20 in FIG. 1 (e.g., an AFC system to facilitate its operation in a 6 GHz radio-frequency band). Additionally, wireless access point 10-1 (e.g., wireless communication circuitry 26 controlled by processing circuitry 22) may transmit (e.g., broadcast) a message such as location message 32-1 containing location information of wireless access point 10-1 as determined by wireless access point 10-1. As one illustrative example, message 32-1 may be a beacon message (e.g., a WLAN beacon frame or any other type of periodic and/or broadcast message) containing an information element that includes the location information. In particular, the location information conveyed in message 32-1 may include the geolocation of a geolocation reference device (e.g., wireless access point 10-1 in the example of FIG. 3), the confidence interval of the location (e.g., of the geolocation of wireless access point 10-1 in the example of FIG. 3), and a hop count value indicating a degree of proximity (e.g., a number of devices) to the geolocation reference device. As examples, a hop count value of 0 indicates that the message-transmitting device is the geolocation reference device, a hop count value of 1 indicates that the message-transmitting device is one hop or device away from (and is therefore adjacent to) the geolocation reference device, a hop count value of 2 indicates that the message-transmitting device is two hops or devices away from the geolocation reference device (e.g., is separated from the geolocation reference device by an intervening device), etc. According to this scheme, the hop count value in location message 32-1 transmitted by wireless access point 10-1 may be 0. If desired, other indicators for proximity to a geolocation reference device may be used in transmitted location messages.

In the example of FIG. 3, wireless access point 10-2 may lack functional geopositioning circuitry (e.g., lack a functional GPS module) or may otherwise be unable to obtain its own geographical coordinates (e.g., due to lack of visibility and therefore line-of-sight connection to satellites). After wireless communication circuitry 26 (FIG. 2) of wireless access point 10-2 receives location message 32-1, wireless access point 10-2 may obtain its location information based on message 32-1. In particular, wireless access point 10-2 may obtain the geolocation of the geolocation reference device (e.g., wireless access point 10-1) in message 32-1 and may perform a distance determination operation with the message-transmitting device (e.g., wireless access point 10-1) to determine the distance from wireless access point 10-2 to the message-transmitting device.

In general, wireless access point 10-2 (e.g., processing circuitry 22 using wireless communication circuitry 26 therein) may exchange messages or signals 36-1 with wireless access point 10-1 (e.g., processing circuitry 22 using wireless communication circuitry 26 therein) to determine the distance to wireless access point 10-1. Wireless access point 10-2 may use any suitable distance determination technique(s) and/or make any suitable number of distance measurements to determine a distance to wireless access point 10-1. As one illustrative example, wireless access point 10-2 may send IEEE 802.11mc Fine Time Measurement (FTM) requests (e.g., request messages 36-1) to wireless access point 10-1, receive IEEE 802.11mc FTM responses (e.g., response messages 36-1) from wireless access point 10-1, and process (timing information associated with) each pair of request and response messages to make a distance measurement. Accordingly, wireless access point 10-2 may perform a distance determination operation by making multiple distance measurements and may process the results of the distance measurements to determine a distance to wireless access point 10-1 (e.g., a distance that is an average of measured distances, that removes outliers prior to averaging, and/or that otherwise is a result of processing of the measured distances to provide an estimate of the actual distance with some degree of uncertainty). If desired, a distance determination operation may include a single distance measurement which is directly used as the measured distance.

As other examples of distance determination operations, wireless access point 10-2 may use Received Signal Strength Indicator (RSSI) based measurements (e.g., based on signal strength of signals 36-1 received from wireless access point 10-1), may use radio-frequency ranging (e.g., based on a version of a radio-frequency signal 36-1 transmitted by wireless access point 10-2 and reflected back from wireless access point 10-1), and/or may use other types of distance determination techniques to perform one or more distance measurements to obtain a distance to wireless access point 10-1.

After these operations, wireless access point 10-2 may have obtained the geolocation of the geolocation reference device (e.g., wireless access point 10-1) from within received location message 32-1 and may have obtained a distance to the geolocation reference device (e.g., based on exchanging distance measurement messages or signals 36-1 with wireless access point 10-1). The combination of these two pieces of information (e.g., the geolocation information of the geolocation reference device and the distance to the geolocation reference device) provides the (relative) location of wireless access point 10-2 and is sometimes referred to herein as the location information or location of wireless access point 10-2. This location of wireless access point 10-2 may be subject to uncertainty characterized by a location uncertainty value (a confidence interval), which may also be considered part of the location information or location of wireless access point 10-2.

Wireless access point 10-2 may determine its location uncertainty value by adding or otherwise taking into account the location uncertainty value associated with the location of the geolocation reference device (e.g., obtained from within received location message 32-1) and the uncertainty (value(s)) of the distance determination operation performed by wireless access point 10-2. Similar to the location uncertainty value of the geolocation reference device (e.g., wireless access point 10-1), the location uncertainty value of wireless access point 10-2 may also be a distance value indicative of a radius of a circular area (e.g., the area of dashed circle 34-2 with the device location at its center) within which the device is located with a given confidence level (e.g., a confident level of at least 90%, at least 95%, at least 99%, etc.).

To facilitate operation in one or more radio-frequency bands (e.g., in a 6 GHz radio-frequency band), wireless access point 10-2 may report, to management system 20 in FIG. 1, its location information which contains the geolocation of the geolocation reference device, the distance to the geolocation reference device, and the location uncertainty value associated with the location of wireless access point 10-2. Responsive to sending the location information of wireless access point 10-2 to management system 20, wireless access point 10-2 may receive, from management system 20, operating parameters based on which operation in the one or more radio-frequency bands by wireless access point 10-2 is permitted. Accordingly, wireless access point 10-2 may subsequently operate in the one or more radio-frequency bands using the received operating parameters.

Additionally, wireless access point 10-2 (e.g., wireless communication circuitry 26 controlled by processing circuitry 22) may transmit (e.g., broadcast) its own message such as location message 32-2 containing location information of wireless access point 10-2 as determined by wireless access point 10-2. As one illustrative example, message 32-2 may be a beacon message (e.g., a WLAN beacon frame or any other type of periodic and/or broadcast message) containing an information element that includes the location information. In particular, the location information conveyed in message 32-2 may include the geolocation of the geolocation reference device (e.g., wireless access point 10-1), the distance from the message-transmitting device (e.g., wireless access point 10-2) to the geolocation reference device, the confidence interval of the location of the message-transmitting device, and a hop count value indicating proximity to the geolocation reference device (e.g., a value of 1 in this example if the scheme detailed in connection with message 32-1 is followed).

The transmission of location message 32-2 may allow other wireless access points 10 further away from the geolocation reference device to still obtain their location information based on the geolocation of the geolocation reference device (e.g., wireless access point 10-1).

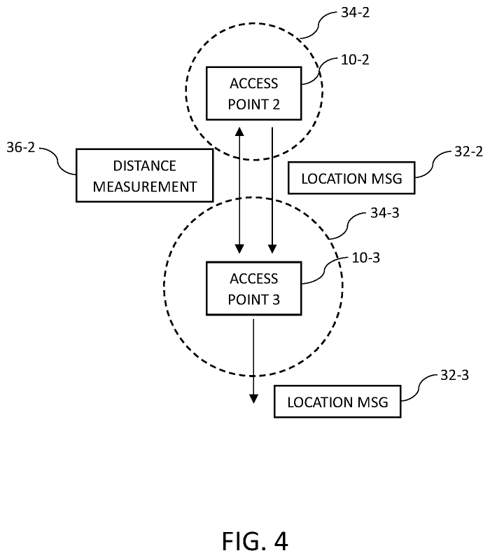

The use of location message 32-2 is further illustrated in connection with FIG. 4.

In the example of FIG. 4, a third access point 10-3 (e.g., a third instance of access point 10 in FIGS. 1 and 2) may be configured to receive message 32-2 transmitted (e.g., broadcast) by wireless access point 10-2. Similar to wireless access point 10-2, wireless access point 10-3 may lack functional geopositioning circuitry (e.g., lack a functional GPS module) or may otherwise be unable to obtain its own geographical coordinates (e.g., due to lack of visibility and therefore line-of-sight connection to satellites). After wireless communication circuitry 26 (FIG. 2) of wireless access point 10-3 receives location message 32-2, wireless access point 10-3 may obtain its location information based on message 32-2. In particular, wireless access point 10-3 may obtain the geolocation of the geolocation reference device (e.g., wireless access point 10-1) in message 32-1 and may also obtain the distance from the message-transmitting device (e.g., wireless access point 10-2) to the geolocation reference device. Wireless access point 10-3 may perform a distance determination operation with the message-transmitting device (e.g., wireless access point 10-2) to determine the distance from wireless access point 10-3 to the message-transmitting device.

In general, wireless access point 10-3 may exchange messages or signals 36-2 with wireless access point 10-2 to determine the distance to wireless access point 10-2. Wireless access point 10-3 may use any suitable distance determination technique(s) and/or make any suitable number of distance measurements to determine a distance to wireless access point 10-2. As one illustrative example, wireless access point 10-3 may send IEEE 802.11mc Fine Time Measurement (FTM) requests (e.g., request messages 36-2) to wireless access point 10-2, receive IEEE 802.11mc FTM responses (e.g., response messages 36-2) from wireless access point 10-2, and process (timing information associated with) each pair of request and response messages to make a distance measurement. Accordingly, wireless access point 10-3 may perform a distance determination operation by making multiple distance measurements and may process the results of the distance measurements to determine a distance to wireless access point 10-2 (e.g., a distance that is an average of measured distances, that removes outliers prior to averaging, and/or that otherwise is a result of processing of the measured distances to provide an estimate of the actual distance with some degree of uncertainty). If desired, a distance determination operation may include a single distance measurement which is directly used as the measured distance.

As other examples of distance determination operations, wireless access point 10-3 may use RSSI-based measurements (e.g., based on signal strength of signals 36-2 received from wireless access point 10-2), may use radio-frequency ranging (e.g., based on a version of a radio-frequency signal 36-2 transmitted by wireless access point 10-3 and reflected back from wireless access point 10-2), and/or may use other types of distance determination techniques to perform one or more distance measurements to obtain a distance to wireless access point 10-2.

After these operations, wireless access point 10-3 may have obtained the geolocation of the geolocation reference device (e.g., wireless access point 10-1) from within received location message 32-2, may have obtained the distance between the message-transmitting device (e.g., wireless access point 10-2) and the geolocation reference device within received location message 32-2, and may have obtained a distance to the message-transmitting device (e.g., based on exchanging distance measurement messages or signals 36-1 with wireless access point 10-2). Wireless access point 10-3 may determine its own distance to the geolocation reference device by adding or otherwise taking into account the distance between the message-transmitting device and the geolocation reference device (conveyed in message 32-2) and the distance between wireless access point 10-3 and the message-transmitting device.

The combination of these two pieces of information (e.g., the geolocation information of the geolocation reference device and the distance between wireless access point 10-3 and the geolocation reference device) provides the (relative) location of wireless access point 10-3 and is sometimes referred to herein as the location information or location of wireless access point 10-3. This location of wireless access point 10-3 may be subject to uncertainty characterized by a location uncertainty value (a confidence interval), which may also be considered part of the location information or location of wireless access point 10-3.

Wireless access point 10-3 may determine its location uncertainty value by adding or otherwise taking into account the location uncertainty value associated with the location of the message-transmitting device (e.g., obtained from within received location message 32-2) and the uncertainty (value(s)) of the distance determination operation performed by wireless access point 10-3. Similar to the location uncertainty values of the geolocation reference device and the message-transmitting device, the location uncertainty value of wireless access point 10-3 may also be a distance value indicative of a radius of a circular area (e.g., the area of dashed circle 34-3 with the device location at its center) within which the device is located with a given confidence level (e.g., a confident level of at least 90%, at least 95%, at least 99%, etc.).

To facilitate operation in one or more radio-frequency bands (e.g., in a 6 GHz radio-frequency band), wireless access point 10-3 may report, to management system 20 in FIG. 1, its location information which contains the geolocation of the geolocation reference device, the distance to the geolocation reference device (e.g., the sum of the distance between wireless access point 10-3 and wireless access point 10-2 and the distance between wireless access point 10-2 and the geolocation reference device), and the location uncertainty value associated with the location of wireless access point 10-3. Responsive to sending the location information of wireless access point 10-3 to management system 20, wireless access point 10-3 may receive, from management system 20, operating parameters based on which operation in the one or more radio-frequency bands by wireless access point 10-3 is permitted. Accordingly, wireless access point 10-3 may subsequently operate in the one or more radio-frequency bands using the received operating parameters.

Additionally, wireless access point 10-3 (e.g., wireless communication circuitry 26 controlled by processing circuitry 22) may transmit (e.g., broadcast) its own message such as location message 32-3 containing location information of wireless access point 10-3 as determined by wireless access point 10-3. As one illustrative example, message 32-3 may be a beacon message (e.g., a WLAN beacon frame or any other type of periodic and/or broadcast message) containing an information element that includes the location information. In particular, the location information conveyed in message 32-3 may include the geolocation of the geolocation reference device (e.g., wireless access point 10-1), the distance from the message-transmitting device (e.g., wireless access point 10-3) to the geolocation reference device, the confidence interval of the location of the message-transmitting device, and a hop count value indicating proximity to the geolocation reference device (e.g., a value of 2 in this example if the scheme detailed in connection with messages 32-1 and 32-2 is followed).

The transmission of location message 32-3 may allow wireless access points 10 even further away from the geolocation reference device to still obtain their location information based on the geolocation of the geolocation reference device (e.g., wireless access point 10-1).

This cascading mechanism of wireless access point locationing (e.g., location determination), reporting, and location message transmission (e.g., broadcast) may continue for any suitable number of wireless access points 10. In other words, a plurality of wireless access points 10 may each rely on the geolocation of the same geolocation reference device, calculate a distance to the geolocation reference device by adding the distance from the message-transmitting device to the geolocation reference device and the determined distance to the message-transmitting device, and calculate a location uncertainty value of the access point location by adding the location uncertainty value associated with the location of the message-transmitting device and the uncertainty of the distance determination operation.

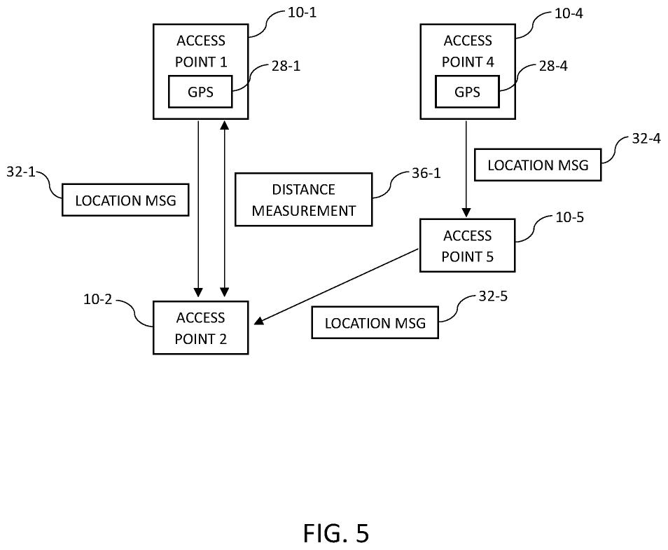

With the transmission of location messages 32 by multiple wireless access points 10 in network 8 (and/or by other geolocation reference devices), a given wireless access point 10 may receive, using wireless communication circuitry 26 (FIG. 2), location messages 32 from multiple neighboring access points and/or other devices. The given wireless access point 10 may selectively perform locationing (e.g., wireless access point location determination) based on a given one of the location messages 32. FIG. 5 is a diagram of an illustrative wireless access point that receives two messages containing location information from two corresponding neighboring wireless access points.

In the example of FIG. 5, wireless access point 10-2 may receive, using wireless communication circuitry 26 (FIG. 2), location message 32-1 from wireless access point 10-1 serving as a geolocation reference device in the same manner as described in connection with FIG. 3. Additionally, wireless access point 10-2 may also receive, using wireless communication circuitry 26 (FIG. 2), location message 32-5 indicating the location of access point 10-5 relative to a geolocation of wireless access point 10-4 as determined by GPS module 28-4 on access point 10-4 (serving as another geolocation reference device). In analogous manner as described in FIG. 3 in connection with wireless access point 10-2 with respect to wireless access point 10-1, wireless access point 10-5 may receive, using wireless communication circuitry 26 (FIG. 2), location message 32-4 containing the geolocation of wireless access point 10-4, may determine its own (relative) location based on the content of location message 32-4 (and based on a distance determination operation with respect to wireless access point 10-4), and may send its own location information in location message 32-5.

In some illustrative configurations described herein as an example, a wireless access point such as wireless access point 10-2 may determine a location message to use for generating its own location information based on the proximity of the message-transmitting device to a geolocation reference device. In the example of FIG. 5, location message 32-1 may contain proximity-to-geolocation-reference information indicating that the message-transmitting device (e.g., wireless access point 10-1) is itself the geolocation reference device (e.g., contains a hop count value of 0), while location message 32-5 may contain proximity-to-geolocation-reference information indicating that the message-transmitting device (e.g., wireless access point 10-5) is one hop away or adjacent to its geolocation reference device (e.g., contains a hop count value of 1). Accordingly, wireless access point 10-2 may determine (e.g., based on comparing the two hop count values or other corresponding proximity-to-geolocation-reference information) that wireless access point 10-1 which transmitted location message 32-1 is closest to a geolocation reference device and may consequently perform locationing in the same manner described in connection with FIG. 3 (e.g., using message 32-1 and with respect to wireless access point 10-1).

In general, a given wireless access point may receive location messages containing location information from any suitable number of neighboring wireless access points. As illustrated by the example of FIG. 5, it may be preferable for a given wireless access point to obtain its own location information (e.g., perform locationing) using a particular neighboring wireless access point (out of multiple neighboring wireless access points) that is closer to a geolocation reference device (e.g., with a lower hop count value in its transmitted location message) to improve confidence in and lower uncertainty of the obtained location information.

If desired, other criteria (e.g., RSSI-based criteria, distance measurement criteria, etc.) may be used in addition to or instead of a proximity-to-geolocation-reference criterion to determine the given neighboring wireless access point (out of multiple neighboring access points) with which to perform locationing.

In one illustrative configuration, if a plurality of neighboring wireless access points send location messages that indicate the same proximity to one or more geolocation reference devices (e.g., contain the same lowest hop count value), the given wireless access point may select a set of one or more neighboring wireless access points in the plurality based on received signal strength (e.g., as determined using RSSI measurements) from the set of neighboring wireless access points exceeding a received signal strength threshold value. The set of neighboring wireless access points transmitting signals exceeding the received signal strength threshold value may further be compared to each other based on their respective distances to the given wireless access point and/or based on a rate of successful and/or accurate distance measurements (e.g., a detection rate) exceeding a detection rate threshold value, to further determine a finalized neighboring wireless access point in the set that is closest to the given wireless access point (while exceeding a minimum detection rate threshold value). The given wireless access point may then perform locationing with this finalized neighboring wireless access point and its transmitted location message (e.g., in an analogous manner described in connection with FIG. 3 or FIG. 4).

In some illustrative network configurations described herein as examples, one or more wireless access points 10 serving as geolocation reference device(s) may be outdoor wireless access points (e.g., located outside of buildings or other structure or generally in uncovered environments) that have visibility (e.g., line-of-sight) to satellites for obtaining their geolocation(s) using on-device geopositioning circuitry (e.g., GPS modules) while other access points that obtain location information relative to a geolocation of a geolocation reference device may be indoor access points (e.g., located within buildings or other structures or generally in covered environments). These examples are merely illustrative. If desired, an outdoor wireless access point having faulty geopositioning circuitry may obtain location information relative to a geolocation of a geolocation reference device. If desired, an indoor wireless access point (e.g., located near a building window) having geopositioning circuitry and line-of-sight to satellites may serve as a geolocation reference device.

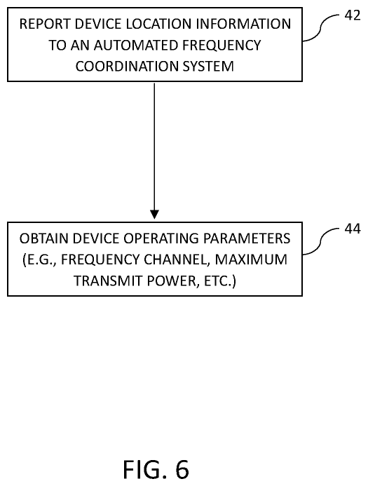

FIG. 6 is a flowchart of illustrative operations performed by a wireless access point (e.g., any of wireless access points 10 in FIGS. 1-5) prior to operating in a particular frequency band. In particular, these operations may be performed with processing circuitry 22 (FIG. 2) in wireless access point 10 using wireless communication circuitry 26 (FIG. 2) and other components 30 (FIG. 2) such as input-output interfaces in wireless access point 10. In configurations described herein as an illustrative example, the operations described in connection with FIG. 6 may be performed by processing circuitry 22 executing software instructions stored on memory circuitry 24. If desired, one or more operations described in connection with FIG. 6 may be performed by other dedicated hardware components in wireless access point 10.

At block 42, processing circuitry 22 may obtain (access point) device location information and report the obtained device location information to a management system such as an Automated Frequency Coordination (AFC) system (e.g., system 20 in FIG. 1). As examples, the device location information may be a geolocation of the reporting wireless access point when processing circuitry 22 can obtain the geolocation directly using on-device geopositioning circuitry (e.g., part of wireless communication circuitry 26 in wireless access point 10) or may be a relative location of the reporting wireless access point with respect to a geolocation of an external geolocation reference device when processing circuitry 22 determines the relative location based on performing the operations described in connection with FIGS. 3-5. Processing circuitry 22 may report the device location information by sending or outputting the device location information using input-output interface(s) of wireless access point 10 for traversal through network 8 to system 20 (FIG. 1).

At block 44, responsive to the reporting of the device location information, processing circuitry 22 may obtain device operating parameters from the AFC system. In particular, processing circuitry 22 may receive the operating parameters at input-output interface(s) of wireless access point 10 from system 20 after traversal through network 8 (FIG. 1). The device operating parameters may be for the radio-frequency band (e.g., the 6 GHz radio-frequency band) in which wireless access point 10 intends to operate when reporting its location information and may take into account other incumbent radio-frequency devices operating in the same radio-frequency band. The operating parameters may specify one or more radio-frequency channels in the radio-frequency band, a maximum transmit power, and/or other radio-frequency operating parameters. Processing circuitry 22 may subsequently configure and control wireless communication circuitry 26 to operate in the radio-frequency band with the received operating parameters.

Processing circuitry 22 may perform the operations described in connection with blocks 42 and 44 with any suitable periodicity and/or any other suitable times. In one illustrative example, the AFC system may specify a frequency or periodicity (e.g., once every day) with which device location information is to be reported and processing circuitry 22 may perform the operations described in connection with blocks 42 and 44 at the specified frequency or periodicity.

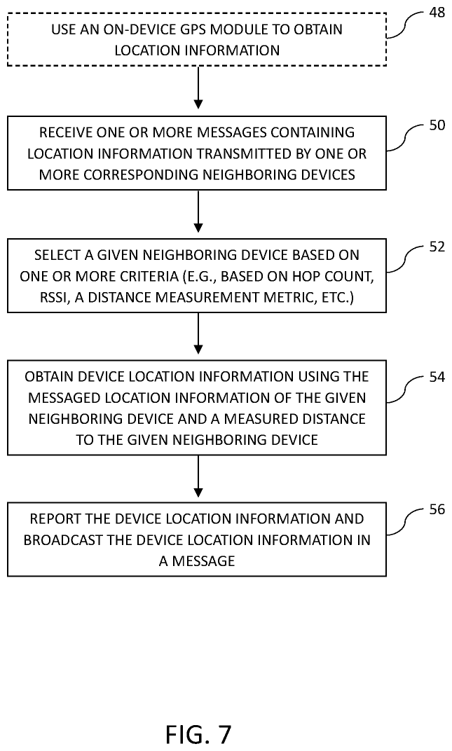

FIG. 7 is a flowchart of illustrative operations performed by a wireless access point (e.g., any of wireless access points 10 in FIGS. 1-5) to obtain its location information. If desired, at least some (e.g., all) of the operations described in connection with FIG. 7 may be performed as part of block 42 in FIG. 6. In particular, these operations may be performed with processing circuitry 22 (FIG. 2) in wireless access point 10 using wireless communication circuitry 26 (FIG. 2) and other components 30 (FIG. 2) such as input-output interfaces in wireless access point 10. In configurations described herein as an illustrative example, the operations described in connection with FIG. 7 may be performed by processing circuitry 22 executing software instructions stored on memory circuitry 24. If desired, one or more operations described in connection with FIG. 7 may be performed by other dedicated hardware components in wireless access point 10.

At block 48, processing circuitry 22 in wireless access point 10 may use an on-device GPS module (or other types of geopositioning circuitry) to obtain device location information (e.g., a geolocation of wireless access point 10). In configurations in which wireless access point 10 lacks geopositioning circuitry operable to obtain the device location information (e.g., when any of access points 10-2, 10-3, 10-5 in FIGS. 3-5 performs the operations described in connection with FIG. 7), the operations of block 48 may be omitted or may have failed. In configurations in which wireless access point is able to successfully perform the operations of block 48 (e.g., when any of access points 10-1 and 10-4 in FIGS. 3-5 performs the operations described in connection with FIG. 7), the operations of blocks 50, 52, and 54 may be omitted and processing may proceed directly to the operations of block 56.

At block 50, processing circuitry 22 may receive, e.g., using wireless communication circuitry 26 in wireless access point 10, one or more (location) messages containing location information transmitted by one or more corresponding neighboring devices (e.g., wireless access points that are radio-frequency neighbors of wireless access point 10 as determined by processing circuitry 22 and/or wireless communication circuitry 26 based on satisfying a received signal strength criterion and/or other criteria). If desired, these one or more location messages (e.g., messages 32 in the examples of FIGS. 3-5) may be received using circuitry other than wireless communication circuitry 26 (e.g., used wired connection(s), relayed by one or more intervening devices from the one or more corresponding neighboring devices, etc.)

At block 52, processing circuitry 22 may select a given neighboring device (e.g., a given neighboring access point) based on one or more criteria. As examples, the criteria may include a proximity-to-geolocation-reference criterion (e.g., indicated by hop counts in the location messages received at block 50, with closest to geolocation reference device being preferred), a received signal strength criterion (e.g., based on an RSSI of a neighboring device exceeding a RSSI threshold), a distance-to-neighboring-device criterion (e.g., based on a shortest determined distance to a neighboring device), a distance measurement metric criterion (e.g., based on an accuracy rate and/or a success rate associated with distance measurements to the neighboring device exceeding rate threshold(s)), and/or other suitable criteria for discriminating between neighboring devices.

In one illustrative configuration, processing circuitry 22 may be configured to perform a first selection based on closest proximity to the same or different geolocation reference device(s) to select one or more neighboring device(s). If necessary (e.g., if the first selection results in multiple neighboring devices being selected), processing circuitry 22 may be further configured to perform a second selection from the resulting neighboring devices (after the first selection), based on a received signal strength of signals from the resulting neighboring devices exceeding a minimum received signal strength threshold, to select one or more neighboring device(s). If necessary (e.g., if the second selection results in multiple neighboring devices being selected), processing circuitry 22 may be further configured to perform a third selection from the resulting neighboring devices (after the second selection) to select a closest neighboring device, determined by performing distance determination operations with the resulting neighboring devices, that has a distance measurement success and/or accuracy rate exceeding a minimum success and/or accuracy rate threshold (e.g., out of N number of attempted distance measurements X number of distance measurements were successful and/or accurate, and a ratio of X to N is greater than a ratio threshold of Y to N).

This configuration of processing circuitry 22 for discriminating between neighboring devices is merely illustrative. If desired, processing circuitry 22 may perform any suitable type of selection processes (e.g., random selection of similarly proximate-to-geolocation-reference neighboring devices, specified by user input configurations, etc.)

At block 54, processing circuitry 22 may obtain its own device location information using the messaged location information from the selected neighboring device and by measuring, e.g., using wireless communication circuitry 26, a distance to the selected neighboring device. The measured distance to the selected neighboring device may be the distance to the geolocation reference device (e.g., as described in connection with FIG. 3, when the neighboring device serves as the geolocation reference device) or may be only a part of the distance of the geolocation reference device (e.g., as described in connection with FIG. 4, with the other part of the distance of the geolocation reference device being indicated within the messaged location information from the selected neighboring device).

At block 56, processing circuitry 22 may report the obtained device location information to a wireless access point management system (e.g., as similarly described for block 42 in FIG. 6 in connection with the AFC system). Processing circuitry 22 may transmit (e.g., broadcast), using wireless communication circuitry 26, the device location information in a (location) message such as that other access points may perform locationing based on the message broadcasted in block 56 and the broadcasting wireless access point 10.

The methods and operations described above in connection with FIGS. 1-7 may be performed by the components of one or more wireless access points and/or server or other host equipment using software, firmware, and/or hardware (e.g., dedicated circuitry or hardware). Software code for performing these operations may be stored on non-transitory computer-readable storage media (e.g., tangible computer readable storage media) stored on one or more of the components of the wireless access point(s) and/or server or other host equipment. The software code may sometimes be referred to as software, data, instructions, program instructions, or code. The non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the wireless access point(s) and/or server or other host equipment (e.g., compute devices of system 20 in FIG. 1, processing circuitry 22 of access point 10 in FIG. 2, etc.).

The foregoing is merely illustrative and various modifications can be made to the described embodiments. The foregoing embodiments may be implemented individually or in any combination.

What is claimed is:

1. A wireless access point operable with an additional wireless access point, the wireless access point comprising:
memory circuitry; and
processing circuitry coupled to the memory circuitry and configured to:
obtain, from the additional wireless access point, a geolocation of a geolocation reference device separate from the additional wireless access point;
obtain a distance to the additional wireless access point;
obtain a location of the wireless access point, wherein the location is specified by the geolocation of the geolocation reference device and a distance to the geolocation reference device that includes the distance to the additional wireless access point; and
output the location of the wireless access point.

2. The wireless access point defined in claim 1, wherein the processing circuitry is configured to determine the distance to the geolocation reference device using the obtained distance to the additional wireless access point and using a distance between the additional wireless access point and the geolocation reference device.

3. The wireless access point defined in claim 2, wherein the processing circuitry is configured to obtain, from the additional wireless access point, the distance between the additional wireless access point and the geolocation reference device.

4. The wireless access point defined in claim 1, wherein the processing circuitry is configured to obtain the distance to the additional wireless access point by performing one or more distance measurements and wherein the processing circuitry is configured to determine an uncertainty value associated with the location of the wireless access point based on an uncertainty associated with the one or more distance measurements.

5. The wireless access point defined in claim 4, wherein the processing circuitry is configured to determine the uncertainty value associated with the location of the wireless access point further based on an uncertainty value associated with a location of the additional wireless access point.

6. The wireless access point defined in claim 5, wherein the uncertainty value associated with the location of the wireless access point indicates an area within which the location of the wireless access point lies with at least a given confidence level.

7. The wireless access point defined in claim 5, wherein the processing circuitry is configured to receive a location message from the additional wireless access point and wherein the received location message includes the geolocation of the geolocation reference device, a distance between the additional wireless access point and the geolocation reference device, and the uncertainty value associated with the location of the additional wireless access point.

8. The wireless access point defined in claim 1 further comprising:
wireless communication circuitry coupled to the processing circuitry, wherein the processing circuitry is configured to output the location of the wireless access point by transmitting, using the wireless communication circuitry, a location message that includes the location of the wireless access point and wherein the location message includes information indicative of proximity of the wireless access point to the geolocation reference device.

9. The wireless access point defined in claim 8, wherein the processing circuitry is configured to report the location of the wireless access point to a wireless access point management system.

10. The wireless access point defined in claim 1, wherein the wireless access point and the additional wireless access point each lack geopositioning circuitry operable to obtain a geolocation.

11. A wireless access point comprising:
wireless communication circuitry;
memory circuitry;
processing circuitry coupled to the wireless communication circuitry and the memory circuitry and configured to:
obtain a location of a geolocation reference device;
obtain a distance to the geolocation reference device; and
transmit, using the wireless communication circuitry, a location message that includes the location of the geolocation reference device and the distance to the geolocation reference device.

12. The wireless access point defined in claim 11, wherein the location message includes information indicative of proximity to the geolocation reference device.

13. The wireless access point defined in claim 12, wherein the processing circuitry is configured to obtain a wireless access point location uncertainty value and wherein the location message includes wireless access point location uncertainty value.

14. The wireless access point defined in claim 11, wherein the location message is a beacon message broadcasted by processing circuitry using the wireless communication circuitry.

15. The wireless access point defined in claim 11, wherein the processing circuitry is configured to obtain the distance to the geolocation reference device by performing distance measurement using request and response messages, using received signal strength, or using radio-frequency ranging.

16. The wireless access point defined in claim 11, wherein the wireless access point lacks geopositioning circuitry operable to obtain a geolocation of the wireless access point.

17. A wireless access point operable with first and second neighboring devices, the wireless access point comprising:
wireless communication circuitry;
memory circuitry;
processing circuitry coupled to the wireless communication circuitry and the memory circuitry and configured to:
receive a first message from the first neighboring device containing first information indicative of proximity to a first geolocation reference device;
receive a second message from the second neighboring device containing second information indicative of proximity to the first geolocation reference device or a second geolocation reference device; and
based on a comparison between the first and second information, obtain a location of the wireless access point using the first message and the first neighboring device.

18. The wireless access point defined in claim 17, wherein the comparison indicates that the first neighboring device is closer in proximity to the first geolocation reference device than the second neighboring device is to the first geolocation reference device or the second geolocation reference device.

19. The wireless access point defined in claim 17, wherein the comparison indicates that the first neighboring device has a same degree of proximity to the first geolocation reference device as the second neighboring device has to the first geolocation reference device or the second geolocation reference device and wherein the processing circuitry is configured to obtain the location of the wireless access point using the first message and the first neighboring device further based on a received signal strength criterion, a distance-to-neighboring-device criterion, or a distance measurement metric criterion.

20. The wireless access point defined in claim 17, wherein the first message includes a geolocation of the first geolocation reference device, wherein the processing circuitry is configured to measure a distance to the first neighboring device, and wherein the processing circuitry is configured to obtain the location of the wireless access point using the geolocation of the first geolocation reference device and the measured distance to the first neighboring device.
